(19) United States
(12) Patent Application Publication
(10) Pub. No.: US 2009/0223745 A1
(43) Pub. Date: Sep. 10, 2009

(54) CHAIN LUBRICATION TOOL

(76) Inventor: Peter J. Marcucci, North Port, FL (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/041,839

(22) Filed: Mar. 4, 2008

(51) Int. Cl. F16N 7/00; B65D 83/00

(52) U.S. Cl. 184/15.2; 222/395

(57) ABSTRACT

A chain lubrication application tool is provided, the tool having an L-shaped body and a swivel fitting attached to the body. The L-shaped body has a top member and a side member, the top member and side member forming the L-shaped body. The swivel fitting is attached to the top member of the L-shaped body and has an inlet operable to accept lubrication from a lubricant dispensing container and an outlet to supply the lubrication to a drive chain that can be located below the top member of the L-shaped body.

### FIELD OF THE INVENTION

The present invention relates to a tool for lubricating a drive chain, and in particular to a tool having a swivel fitting that aids in the lubrication of a drive chain.

### BACKGROUND OF THE INVENTION

Bicycles, motorcycles, industrial equipment and other types of machines can use drive chains in combination with sprockets in order to transmit power from one sprocket to another sprocket. Such drive chains are typically made from a plurality of spaced apart pins extending between side plates, each pin typically being within a roller. The combination of the pins, rollers and side plates provides a chain having openings that correspond to the teeth on a sprocket, the teeth on the sprocket engaging the chain and allowing the transfer of power.

As with most movable parts used with machines, the drive chain typically requires lubrication in order to aid in the movement of the pins, rollers and side plates relative to each other and to reduce wear and friction between the drive chain and the sprockets. One method of applying lubrication to such a drive chain includes taking an aerosol can with lubricant therein and spraying the lubricant onto the chain. Most aerosol cans can be purchased with a small tube that fits within the aerosol can actuator in order to direct the lubricant to the chain and reduce overspray. However, significant overspray can still occur with the use of the tube. In order to reduce the overspray and more appropriately provide lubricant to the drive chains, various tools have been taught in the prior art, the tools attempting to more directly transmit the lubricant to the drive chain. However, heretofore chain lubrication application tools have lacked the ability to be versatile with respect to different chain sizes and have been cumbersome when an individual attempts to hold the tool proximate to the drive chain with one hand and operate the aerosol can containing the lubricant with the other hand. Therefore, a chain lubrication application tool that permits the lubrication device in one hand to control the spray of lubricant as the other hand is used to turn the sprocket to expose the entire length of chain to the lubricant is desirable.

### SUMMARY OF THE INVENTION

A chain lubrication application tool is provided, the tool having an L-shaped body and a swivel fitting attached to the body. The L-shaped body has a top member and a side member, the top member and side member forming the L-shaped body. The swivel fitting is attached to the top member of the L-shaped body and has an inlet operable to accept lubrication from an aerosol container and an outlet to supply the lubrication to a drive chain that can be located below the top member of the L-shaped body.

The tool can include an extension tube that has a first end dimensioned to attach to the inlet of the swivel fitting and a second end dimensioned to attach to a tube extending from the aerosol container. In addition, a tube clamping device can be included, the clamping device having a first end dimensioned to fit at least partially over the extension tube and onto the actuator of the aerosol can to thereby provide an interference fit between the extension tube and the tube extending from the aerosol container.

The top member of the L-shaped body can include an aperture, the aperture being dimensioned such that the outlet of the swivel fitting can fit at least partially therethrough. The aperture is in the for of a slot to provide adjustment for use with larger dimensioned chains as will become more apparent as the description proceeds. In some instances, the outlet can have threads and a nut, the threaded outlet fitting through the aperture and the nut being screwed onto the outlet in order to attach the swivel fitting to the L-shaped body. The swivel fitting can rotate 360 degrees about the outlet and therefore provides freedom of movement between the tool and an aerosol can or container in fluid communication therewith to provide ease of use and versatility.

### BRIEF DESCRIPTION OF THE DRAWINGS

FIG. 1 is a perspective exploded view of an embodiment of the present invention;

FIG. 2 is a perspective view of an embodiment of the present invention illustrating the spraying of lubricant onto a drive chain;

FIG. 3 is a perspective view of the embodiment shown in FIG. 2 wherein the tool is located on an opposite side of the drive chain; and

FIG. 4 is a side cross-sectional view of a tube clamping device.

### DETAILED DESCRIPTION OF THE PRESENT INVENTION

The present invention provides a chain lubrication application tool for applying lubricant to a drive chain. As such, the tool has utility for applying lubricant to a drive system component of a machine.

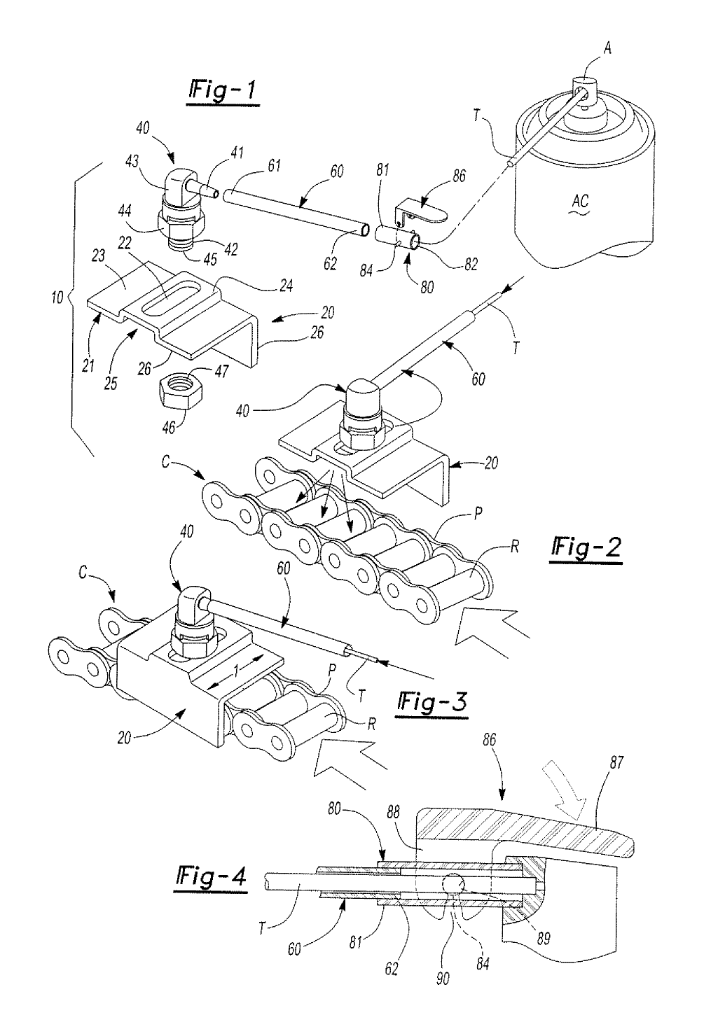

Referring now to FIGS. 1-4, an embodiment of the chain lubrication application tool is shown generally at reference numeral 10. The tool 10 can include an L-shaped body 20 and a swivel fitting 40. The L-shaped body 20 can have a top member 21 and a side member 26. In some instances, the top member 21 and the side member 26 are generally planar in shape. The top member 21 can have an aperture 22, the aperture 22 optionally being in the form of a slot. The top member 21 can also include a base portion 23 and a step or raised portion 24. A channel is formed as part of a bottom surface 26 of the top member 21 and can be the result of the raised portion 24. In some instances, the raised portion 24 has the aperture 22 therewithin.

The swivel fitting 40 can include an inlet 41 that is in fluid communication with an outlet 42. The inlet 41 can be attached to a swivel head 43, the swivel head 43 is operable to rotate 360 degrees about the outlet 42. The outlet 42 can have a multifaceted surface 44 which affords for a wrench or other similar tool to be placed thereon. The outlet 42 can have external threads 45 that are complementary to internal threads 47 of a nut 46. As shown partially in FIG. 2, the outlet 42 has been placed at least partially through the aperture 22 and the nut 46 has been threaded onto a portion of the outlet 42 that extends through the top member 21 and into the channel 25, thereby attaching the swivel fitting 40 to the L-shaped body 20. It is appreciated that the swivel fitting 40 can be attached to the L-shaped body 20 using other methods and/or mechanisms, illustratively including adhesives, welding, self-tapping threads and the like. It is further appreciated that the outlet 42 can have a length that affords for the threading of the nut 46 onto the outlet 42 and yet still not extend below the bottom surface 26 of the base portion 23. In this manner, an outlet for lubrication to be applied to a drive chain is provided and yet the outlet does not come into contact with the drive chain during a lubricating process.

Optionally included can be an extension tube 60, the extension tube 60 having a first end 61 dimensioned to attach to the inlet 41 and in some instances the first end 61 dimensioned to slide over the inlet 41. The extension tube 60 also has a second end 62 that can be dimensioned to slide at least partially over a tube T that extends from an aerosol can actuator A.

Looking now specifically to FIG. 2, the swivel head 40 has been attached to the L-shaped body 20 with the outlet 42 fitting within the aperture 22 of the step portion 24. The extension tube 60 has been placed in fluid communication with the inlet 41 and the tube T such that lubricant supplied from the aerosol can AC can travel through the extension tube 60, into the inlet 41 and exit the outlet 42 in order to contact the chain C with rollers R and side plates P. It is appreciated that the tool 10 can be held by an individual up against the chain C with the side member 20 adjacent the side plates P and the top member 21 parallel to the rollers R. The swivel fitting 40 permits the L-shaped body 20 to adjust to the proper position to properly direct the lubricant to the portion of the chain C to be lubricated.

Looking now specifically at FIG. 3, the chain lubrication application tool 10 has been placed on the other side of the chain C in order to ensure proper lubrication thereof. The aperture 22 being in the form of a slot affords for the movement of the swivel fitting 40 in a back and forth direction 1 to accommodate different size chains.

Optionally included with the lubrication tool 10 is a clamping device 80. As shown in FIGS. 1 and 4, the clamping device 80 can have a first end 81 that is dimensioned to slide at least partially onto and over the second end 62 of the extension tube 60. The clamping device 80 can include a handle 86 that is attached to tabs 84, thereby affording for a swivel handle that can be used to assist in sliding the clamping device 80 onto the extension tube 60. As shown specifically in FIG. 4, sliding of the clamping device 80 onto the extension tube 60 after the tube T has been inserted at least partially within the extension tube 60 can afford for an interference fit between the extension tube 60 and the tube T such that stability between the connection of the two tubes is afforded.

In operation, an individual can assemble the tube T extending from the aerosol can actuator A with the chain lubrication application toot 10, place the tool 10 adjacent to the chain C and by grasping the aerosol container AC and depressing the actuator A afford for lubricant to exit the actuator container AC, pass through the tube T, through the extension tube 60 and through the swivel fitting 40 in order to lubricate the chain C. It is appreciated that an individual can use one hand to grasp the aerosol container AC and depress the actuator A while using the other hand to turn the sprocket to lubricate the entire chain C. It is also appreciated that the rotational movement of the swivel head 40 affords for the aerosol container AC to be moved relative to the tool 10 and yet maintain fluid communication therebetween. In this manner, freedom of movement between the aerosol container AC and the lubrication tool 10 is afforded and provides an improved and more efficient tool.

While the lubrication tool of the present invention has been described for use with an aerosol can it should be apparent that the tool can be used with other containers that have a means of dispensing lubricant from can unto a chain of the like.

It is to also be understood that various modifications can be readily made to the embodiments of the present invention described herein without departing from the spirit and scope thereof. Accordingly, it is to be understood that the invention is not to be limited by the specific illustrated embodiments but by the scope of the appended claims.

I claim:

1. A chain lubrication application tool comprising:
an L-shaped body having a top member and a side member;
a swivel fitting attached to said top member of said L-shaped body and having an inlet operable to accept lubrication from a container and an outlet to supply the lubrication to a drive chain located below said top member of said L-shaped body.

2. The tool of claim 1, further comprising an extension tube having a first end dimensioned to attach to said inlet of said swivel fitting and a second end dimensioned to attach to an aerosol container tube extending from the aerosol container actuator.

3. The tool of claim 2, further comprising a tube clamping device having a first end dimensioned to fit at least partially over said extension tube and a second end dimensioned to fit at least partially over said aerosol container tube.

4. The tool of claim 3, wherein said tube clamping device has a handle, said handle operable to push said first end of tube clamping device at least partially over said extension tube after said aerosol container tube is at least partially within said extension tube, said first end of said tube clamping device providing an interference fit between said extension tube and said aerosol container tube.

5. The tool of claim 1, wherein said top member of said L-shaped body has an aperture, said aperture dimensioned such said outlet of said swivel fitting is at least partially through said top member when said swivel fitting is attached thereto.

6. The tool of claim 5, wherein said aperture is a slot, said slot dimensioned such that said outlet end of said swivel fitting can be slidingly attached to said top member.

7. The tool of claim 5, wherein said top member of said L-shaped body has a raised portion, said raised portion having said aperture therethrough.

8. The tool of claim 1, wherein said outlet has threads and a complimentary nut, said threads and complimentary nut operable to attach said outlet end to said top portion of said L-shaped body.

9. The tool of claim 1, wherein said L-shaped body is made from plastic.

10. A chain lubrication application tool comprising:
an L-shaped body having a generally planar top member and a generally planar side member;
a swivel fitting attached to said top member of said L-shaped body and having an inlet operable to rotate 360 degrees and accept lubrication from a lubricant dispensing container, said swivel fitting also having an outlet in fluid communication with said inlet and operable to spray the lubrication onto a drive chain located proximate to a bottom side of said top member.

11. The tool of claim 10, wherein said top member of said L-shaped body has an aperture, said aperture dimensioned to allow said outlet of said swivel fitting to at least partially fit therewithin.

12. The tool of claim 11, wherein said aperture is a slot, said slot dimensioned such that said outlet end of said swivel fitting can be slidingly attached to said top member.

13. The tool of claim 11, wherein said top member of said L-shaped body has a step portion and a base portion, said step portion being elevated from said base portion and having said aperture therethrough.

14. The tool of claim 13, wherein said top member has a bottom side, said bottom side having a channel formed by said step portion being elevated from said base portion.

15. The tool of claim 14, wherein said aperture is a slot, said slot dimensioned such that said outlet end of said swivel fitting can be slidingly attached to said raised portion.

16. The tool of claim 11, wherein said outlet has threads and a nut, said threads and nut operable to attach said outlet to said top portion when said outlet is placed at least partially through said aperture in said top member.

17. The tool of claim 10, wherein said L-shaped body is made from plastic.

18. A chain lubrication application tool comprising:
an L-shaped body having a generally planar top member and a generally planar side member, said generally planar top member having a step region and a base region, said step region forming a channel within a bottom side of said generally planar top member, said step region also having an aperture therethrough; and
a swivel fitting having an inlet and an outlet, said inlet operable to rotate 360 degrees and accept lubrication from an aerosol container, said outlet attached to said generally planar top member and located at least partially through said aperture, said outlet in fluid communication with said inlet and operable to accept the lubrication from said inlet and spray the lubricate onto a drive chain located proximate to said bottom side of said top member.

19. The tool of claim 18, further comprising an extension tube having a first end dimensioned to attach to said inlet of said swivel fitting and a second end dimensioned to attach to an aerosol container tube extending from the aerosol container actuator.

20. The tool of claim 19, further comprising a tube clamping device having a first end dimensioned to fit at least partially over said extension tube and a second end dimensioned to fit at least partially over said aerosol container tube.
